(19) United States
(12) Patent Application Publication
(10) Pub. No.: US 2007/0225338 A1
(43) Pub. Date: Sep. 27, 2007

(54) Juvenile Hormone Analogs for Control of Leafhopper and Treehopper Pests

(76) Inventors: Russell F. Mizell III, Quincy, FL (US); Peter C. Andersen, Quincy, FL (US)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 10/589,015

(22) PCT Filed: Jun. 29, 2005
(86) PCT No.: PCT/US05/23426

§ 371 Date: May 4, 2007

Related U.S. Application Data
(60) Provisional application No. 60/584,377, filed on Jun. 29, 2004.

(51) Int. Cl. A01N 49/00; A01N 43/40; A01N 47/12

(52) U.S. Cl. 514/345; 514/1; 514/514; 514/549

(57) ABSTRACT

The present invention pertains to compounds and methods for controlling treehopper and leafhopper pests, such as the glassy-winged sharpshooter (GWSS), while conserving their parasites (such as parasitoid wasps). In one embodiment, the compound is a juvenile hormone analog such as methoprene, kinoprene, and hydropene. The invention also concerns pesticidal compositions comprising the compounds of the invention and a pesticidally acceptable carrier. The invention further concerns methods for controlling pests, such as GWSS, while conserving their parasites, by applying a compound or composition of the invention to the pest or pest-inhabited locus.

### CROSS-REFERENCE TO RELATED APPLICATION

The present application claims benefit of U.S. Provisional Application Ser. No. 60/584,377, filed Jun. 29, 2004, which is hereby incorporated by reference herein in its entirety, including any figures, tables, nucleic acid sequences, amino acid sequences, and drawings.

### BACKGROUND OF THE INVENTION

Homalodisca coagulata (Say), the glassy-winged sharpshooter (GWSS), perhaps represents the single greatest threat to the agroecology of California in the history of the state. The threat of GWSS and Pierce's Disease is widely known in California's grape industry. The state's 450,000-plus acres of wine grapes are at risk of potential infection by Pierce's Disease. More than 330,000 cares of raisin and table grape vines are also in jeopardy. GWSS is an effective vector for Pierce's Disease because it is more mobile than other leafhoppers, which also transmit the causative agent, the bacteria Xyllela fastidiosa (Wells et al., International Journal, Systematic Bacteriology, 1987, 37:136-143).

The insect uses its needle-like mouth to tap into the water-conducting tissues of a plant. In addition to its mobility and its varied food sources, GWSS is dangerous because of its ability to move a large quantity of plant juices (proportionately equivalent to a 150-pound human drinking 4,300 gallons) through its system a day. In feeding on plants, GWSS can infect them with lethal diseases, such as Pierce's Disease in grapevines.

Because of GWSS's mobility and voracious feeding habits, the threat is not only to vineyards but also to other crops such as almonds, citrus, peaches, plums, and alfalfa. GWSS's host list includes more than 100 species of plants, including commercial crops and ornamental plants. The combination of Xyllela fastidiosa and a highly mobile vector creates a dynamic and dangerous situation. Agricultural crops are the most visible and quantifiable targets, but decorative plants, landscaping, highway medians, and other non-agricultural plantings are also at risk.

As its name implies, the bacterium that causes Pierce's Disease is fastidious (difficult to culture), and resides in the plant xylem tissue. It is vectored almost exclusively by xylem feeding leafhoppers. Strains of this bacterium are the causal agent of phony peach disease (PPD), plum leaf scald, Pierce's disease (PD) of grapes, citrus variegated chlorosis (CVC), and leaf scorch of almond, coffee, elm, oak, oleander, pear, and sycamore.

Diseases caused by X. fastidiosa are most prevalent in the southeastern United States, but may also occur in California, southern Ontario, and the southern Midwestern states. In north Florida, PPD and PLS can limit peach and plum orchard life. European varieties of wine and table grape are virtually non-existent in the Southeast due to PD, while cultivars of muscadine grapes are resistant. GWSS is capable of establishment throughout the grape growing regions of California (Hoddle, M., Crop Prot., 2004, 23:691-699). As a result, the threat to grape production from Pierce's Disease in California has increased dramatically. The long-term impact on California by GWSS is unknown, but will likely be more severe than the relatively short-term economic impact to date. Currently, approximately $133 million in producer, state and federal funds have been expended in California in efforts to research, suppress, control and contain this pest. Citrus, grape and nursery industries have been severely impacted by the statewide effort to contain GWSS. Other crops such as almonds, peaches and plums are also at risk.

Outbreaks of diseases caused by X. fastidiosa can be expected to occur whenever conditions are favorable for the spread of the disease within and between plants, including seasonal rainfall and other factors affecting leafhopper populations.

X. fastidiosa multiplies and spreads slowly up and down the xylem of the tree from the site of infection. Populations of X. fastidiosa restrict water movement in the xylem, but the true biochemical and biophysical mechanisms involved in symptom manifestation remain unknown.

The first line of defense against GWSS is to eliminate the spread of the vector to uncolonized areas of the state through regulatory efforts and to prevent establishment of new populations through early detection and eradication. During 2002, approximately 2500 infested or adjacent properties were treated in six California counties during rapid response activities and over 65,000 loads of commodities were inspected for GWSS (Anonymous, 2003, Pierce's Disease program, Report to Legislature, California Department of Food and Agriculture (CDFA), page 59). Presently, the primary tools available for regulatory suppression and eradication are early detection followed by chemical pesticide applications (Redak, R. and M. Blua “Impact of layering control tactics on the spread of Pierce's disease by the glassy-winged sharpshooter” Proc., CDFA Pierce's disease research symposium, 2003, pp. 311-313).

The CDFA web site containing the GWSS nursery shipping protocol lists the following chemicals as having some efficacy against GWSS: acephate, cyfluthrin, methiocarb, bifenthrin, deltamethrin, permethrin, fenpropathrin, carbaryl, chlorpyrifos and imidaclopid. Many of these chemicals have logistical limitations including long reentry intervals and other potential side effects that restrict their use or result in added environmental costs as well as elicit severe negative reactions from the public. The mode of action of all of the currently-recommended chemicals registered for use against GWSS is by direct or indirect (feeding suppression by neonicotinoids, repellency by kaolin clay, SURROUND) mortality to the targeted life stages. One of the biggest problems in efforts to contain the spread of GWSS is the lack of effective treatments for GWSS egg masses that occur on many different host plants. Eliminating or limiting the occurrence of egg masses with presently available tools, may now be possible, yet these avenues have not been fully researched.

Redak and Bethke summarized the results of the previous evaluations of pesticides against the GWSS (Redak, R. and J. Bethke “Pesticide screening against the glassy-winged sharpshooter, Homalodisca coagulata (Say), using commercially-available biorational, organic and reduced risk pesticides” Proc., CDFA Pierce's disease research symposium, 2003, pp. 302-307). A large number of chemicals have been evaluated against GWSS life stages that include commercially-available organic, biorational and reduced-risk chemicals. Evaluations of the efficacy of the chemicals were based primarily on mortality to the target stages. Moreover, the results from most previous evaluations were based on short-term tests using typical laboratory and field protocols whereby the mortalities of untreated control organisms are compared to treated individuals over a period of hours or days. Some insect growth regulators, primarily synthetic chitin inhibitors, have been tested over a period of several weeks and found to be effective against GWSS nymphs but caused no adult mortality. However, Redak and Bethke concluded that the activity of these compounds (buprofizen, novaluron and pyriproxifen) was too slow to be useful for eradication purposes. Other researchers have evaluated certain biorationals including cinnamon oil, pyrethrum and piperonyl butoxide—for use in organic production and found limited efficacy against GWSS (Akey, D. et al. “Control of immature and adult glassy-winged sharpshooters: evaluation of biorational insecticides for organic use” Proc., CDFA Pierce's disease research symposium, 2003, pp. 278-281).

The term insect growth regulator (IGR) encompasses a variety of compounds (e.g., synthetic analogs) that mimic hormones and related chemicals essential for chitin synthesis (Staal, G. Ann. Rev. Entomol., 1975, 20:417-460). Examples of ISR include juvenile hormones, such as juvenile hormone I, II, and III; juvenile hormone analogs (also known as juvenile hormone mimics), such as epofenonane, fenoxycarb, hydroprene, kinoprene, methoprene, pyriproxyfen, and triprene; chiton synthesis inhibitors, bistrifluoron, chlorfuazuron, novaluron, and triflumuron; moulting hormones, such as alpha-ecdysone and ecdysterone; moulting hormone agonists, such as chromafenozide, halofenozide, and methoxyfenozide; moulting inhibitors, such as diofenolan; precocones, such as precocene I, II, and III; and ISR that remain unclassified, such as dicyclanil.

Juvenile hormone (JH) is produced in the endocrine system of insects and can mediate or impact a broad array of physiological functions including ecdysis, metamorphosis, diapause, reproduction and metabolism. Six major members of the juvenile hormone group are currently recognized and affect processes in both male and female arthropods (Klowden, M. “Physiological systems in insects” Academic Press, San Diego, 2002, pp. 415). Some affects are the disruption of embryogenesis and ecdysis as well as acute effects on reproductive development including male and female sterilization. Additionally, JH analogs can also cause indirect mortality through the impairment of sensory functions, behavior, feeding, mating, etc. JH analogs are efficacious at extremely low concentrations in microgram to nanogram amounts (Staal, G. Ann. Rev. Entomol., 1975, 20:417-460). In many insect species, JH analogs disrupt diapause, either by terminating diapause out of season or by making diapause permanent, therefore causing sterilization. In some insects, treatment of males with JH analogs has produced negative effects on the reproduction of the females who mate with the treated male (Staal, G. Ann. Rev. Entomol., 1975, 20:417-460). Relatively little biochemical rationale is available for predicting the impact of JH analogs on individual species or life stages of arthropods. The mode of action of JH analogs varies greatly between the members of Insecta. As a result, intensive experimentation with individual species and each chemical must be conducted to determine impacts. Previous use of JH analogs such as methoprene, kinoprene, and hydroprene in California and other states can be viewed at the Pesticide Action Network (PAN) pesticides database (Pesticide Action Network North America, San Francisco, Calif.).

Some previous work with IGRs on leafhoppers has been reported. Juvenile hormone III terminated diapause in the leafhopper Draeculacephala crassicornis by topical, substrate and vapor treatments. Other compounds affected nymph metamorphosis and female reproductive diapause (Kamm, J. and K. Swenson J. Econ. Entomol., 1972, 65:364-367; Reissig, H. and J. Kamm J. Econ. Entomol., 1973, 67:181-183). In a related planthopper, Peregrinus maidis (Heteroptera: Delphacidae), one of the most sensitive morphological structures proved to be the female ovipositor. Treated females had shortened ovipositors as the only visible sign of inhibition and produced eggs that were only half inserted into plant tissue. These eggs did not hatch successfully (Staal, G. Ann. Rev. Entomol., 1975, 20:417-460).

To the present inventors' knowledge, no previous efforts have not been made to evaluate the efficacy of juvenile hormone analogs such as methoprene, kinoprene, and hydroprene against GWSS. These materials may have direct and indirect impacts on the behavior, reproductive or other physiological systems of GWSS. Moreover, the potential long-term impact of treatments to nymphs on the subsequent reproductive activities of adult GWSS has not been evaluated.

### BRIEF SUMMARY OF THE INVENTION

The present invention provides novel methods and compositions for controlling leafhoppers and treehoppers. The present invention concerns juvenile hormone (JH) analogs and their use to control glassy-winged sharpshooters (GWSS) and other leafhopper or treehopper pests. In a preferred embodiment, the JH analogs of the present invention (also collectively referred to herein as “pesticidal compounds” or “pesticidal agents”) reduce oviposition in the pests by suppressing the development of the female reproductive system. The JH analogs affect the target pest but do not harm the parasites that naturally contribute to the control of the target pest by killing its eggs. Thus, the JH analogs provide an advantage over other chemicals in that the two tools can work together in an integrated approach.

The JH analog can be, for example, epofenonane, fenoxycarb, hydroprene, kinoprene, methoprene, pyriproxyfen, and triprene, or any combination of two or more of the foregoing. The JH analogs include addition salts, complexes, or prodrugs such as esters of the analogs described herein, especially the nontoxic pharmaceutically or agriculturally acceptable acid addition salts. The acid addition salts can be prepared using standard procedures in a suitable solvent from the parent compound and an excess of an acid, such as hydrochloric, hydrobromic, sulfuric, phosphoric, acetic, maleic, succinic, ethanedisulfonic or methanesulfonic acids. Esterification to form derivatives such as the methyl or ethyl esters, can also be performed using standard procedures.

In one embodiment, the invention pertains to the use of methoprene, kinoprene, hydroprene, or a combination of two or more of these JH analogs. In another embodiment, methoprene is the JH analog used.

The JH analogs of the invention are particularly active against GWSS, which are common vectors of diseases such as Pierce's Disease. However, in accordance with the present invention, JH analogs can also be used to control other leafhoppers of the family Cicadellidae in the order Hemiptera, which are recognizable by their piercing-sucking mouthparts and by the presence of rows of spine-like setae (hairs) in their hind tibiae.

Another aspect of the present invention pertains to a method for controlling leafhoppers, such as GWSS, and treehoppers, comprising applying to the leafhopper or treehopper, its environment, or a leafhopper- or treehopper-inhabited locus, an effective amount of a JH analog.

Further, in accordance with the present invention, the JH analogs may be utilized alone or in combination with other agents, such as baits, insecticides, toxicants, agars, liquefiers, sweeteners, carriers and the like. Thus, in another aspect, the present invention provides pesticidal compositions comprising one or more JH analogs in combination with a pesticidally acceptable carrier. These pesticidal compositions are formulated for application to the target pests (treehoppers or leafhoppers, such as GWSS) or their locus. The pesticidal combination can further include one or more baits, insecticides, toxicants, agars, liquifiers, sweeteners, etc. In one embodiment, the pesticidal combination includes an additional agent that contributes to control of a treehopper or leafhopper.

In accordance with the present invention, the methods and compositions are safe and effective and, therefore, can be used on any surface or at any location. In addition, the compositions of the present invention can be easily applied directly to areas of infestation and will remain active for extended periods of time. Therefore, the JH analogs of the present invention may be used in residential preparations, commercial crop production, eradication programs and suppression programs for leafhopper or treehopper control.

Experimental data using methoprene indicates that these compounds reduce or eliminate GWSS oviposition by irreversibly suppressing the development of the female reproductive system. The experimental data also show that methoprene has no impact on the egg parasitoids, Gonatocerus spp., and is therefore a biorational chemical tool that can be readily integrated with other chemical and biological controls. Moreover, this class of chemicals will readily satisfy demands of the environmentally-sensitive public.

The experimental data presented herein provides evidence that methoprene severely impacts GWSS female reproduction. For most JH analogs, direct toxic effects are generally absent and all effects are indirect. This necessitates thorough experimentation to determine the potential of these compounds. This is most likely the reason that heretofore these compounds have not been investigated against GWSS and related vectors. This is surprising, given the available literature cited above, the biorational characteristics of the compounds, and the fact that they are currently being used extensively in California against several groups of insect pests in a myriad of indoor (DIACON II—fleas; GENTROL—food areas) and outdoor target sites including aquatic (ALTOSID—mosquitoes) and most importantly California nursery production (ENSTAR II—Heteroptera).

Methoprene, isopropyl (2E,4E)-11-methoxy-3,7,11-trimethyl-2-2,4-dodecadienoate, is registered by the Environmental Protection Agency (EPA) and commercially available as PRECOR for flea control, EXTINGUISH Fire Ant Bait, ALTOSID for larval mosquito control and DIACON II for stored product insect pests in cereal grains, sweet corn, popcorn, birdseed and peanuts. Methoprene does not kill adult insects directly but often adversely affects the immature stages. It is labeled both for indoor and outdoor use, requires no protective equipment to use and has no reentry interval. Kinoprene, [2-propynl (2E,4E)-(7S)-3,7,11-trimethyl-2,4-dodecadienoate], is commercially available as ENSTAR II IGR for control of whiteflies, aphids, soft and armored scales, mealybugs, and fungus gnats in greenhouses and interiorscapes on ornamental plants. Kinoprene has a 12-hour reentry interval. Hydroprene, ethyl (2E,4E)-3,7,11-trimethyl-2,4-dodecadienoate, is commercially available as GENTROL and TURBOCIDE GOLD for use in stored products and for cockroach control in both food and non food areas. These compounds can be tank-mixed with other products.

IGRs, particularly juvenile hormone analogs such as methoprene, kinoprene, and hydroprene, offer a unique mode of action with little, if any, non-target side-effects. They offer an alternative treatment that is highly compatible with and complementary to other insect pest management (IPM) tools and programs. The chemicals are already available and are being used in nursery production for other pests where GWSS is presently causing great economic impact. As stated above, the biggest problem in nursery production relative to regulatory needs is the production and placement of GWSS eggs. This problem requires great expenditure of time and effort to detect the eggs and represents a high risk pathway for the spread of GWSS to uncolonized areas.

The experimental data provided herein suggest that GWSS oviposition can be suppressed or eliminated by treating females. The present inventors have determined that methoprene effectively sterilizes GWSS females. To the present inventors' knowledge, this chemical class has not been previously evaluated for use against GWSS.

The above features and advantages of the present invention will be better understood with reference to the detailed description and examples set out hereinafter. It will also be understood that the specific methods and compositions as set forth herein are exemplary only and are not to be regarded as limitations of this invention.

### DETAILED DESCRIPTION OF THE INVENTION

The present invention pertains to materials and methods useful for the safe and effective control of treehoppers and leafhoppers, such as the glassy-winged sharpshooter (GWSS; Homalodisca coagulata). In a preferred embodiment, the present invention pertains to the control of treehoppers or leafhoppers that attack grapevines. In accordance with the present invention, leafhoppers or treehoppers are controlled by the application of a juvenile hormone analog (JH analog).

The JH analog can be, for example, epofenonane (IUPAC: (±)-6,7-epoxy-3-ethyl-7-methylnonyl 4-ethylphenyl ether; CAS: 2-ethyl-3-[3-ethyl-5-(4-ethylphenoxy(pentyl]-2-methyloxirane); fenoxycarb (IUPAC: ethyl 2-(4-phenoxyphonxy)ethylcarbamate; CAS: ethyl [2-(4-phenoxyphenoxy)ethyl]carbamate); hydroprene (IUPAC: ethyl(E,E)-(RS)-3,7,11-trimethyldodeca-2,4-dienoate; CAS: ethyl (2E,4E)-3,7,11-trimethyl-2,4-dodecadienoate); kinoprene (IUPAC: prop-2-ynyl(E,E)-(RS)-3,7,11-trimethyldodeca-2,4-dienoate; CAS: 2-propynyl (2E,4E)-3,7,11-trimethyl-2,4-dodecadienoate); methoprene (IUPAC: isopropyl(E,E)-(RS)-11-methoxy-3,7,11-trimethyldodeca-2,4-dienoate; CAS: 1-methylethyl (2E,4E)-1-methoxy-3,7,11-trimethyl-2,4-dodecadienoate); pyriproxyfen (IUPAC: 4-phenoxyphenyl (RS)-2-(2-pyridyloxy)propyl ether; CAS: 2-[1-methyl-2-(4-phenoxyphenoxy)ethoxy]pyridine); or triprene (IUPAC: S-ethyl(E,E)-(RS)-11-methoxy-3,7,11-trimethyldodecadienethioate; CAS: S-ethyl (2E,4E)-11-methoxy-3,7,11-trimethyl-2,4-dodecadienethioate), or any combination of two or more of the foregoing.

The JH compound used according to the present invention may be the JH analog itself or a derivative or salt thereof that retains the advantageous leafhopper or treehopper controlling properties of the JH analog. In vitro and in vivo screening assays may be used to identify additional JH analogs that may be used to control leafhoppers or treehoppers in accordance with the method of the present invention, such as those described in U.S. Pat. No. 6,887,661 (Wilson et al.), which is incorporated herein by reference in its entirety.

All leafhoppers of the family Cicadellidae in the order Hemiptera can be controlled using the compositions and methods of the invention. Examples of leafhoppers that can be controlled in accordance with the present invention include, but are not limited to, GWSS, grape leafhopper (Erythroneura spp.), blue-green sharpshooter (Graphocephala atropunctata), potato leafhopper (Empoasca fabae), beet leafhopper (Circulifer tenellus), white apple leafhopper (Typhlocyba pomaria), rose leafhopper (Edwardsiana rosae), mango leafhopper (Idioscopus nitidulus and I. clypealis), three-banded leafhopper (Erythroneura tricincta), variegated leafhopper (Sophonia rufofascia), two-spotted leafhopper (Sophonia rufofascia), and aster or six-spotted leafhopper (Macrosteles quadrilineatus).

In one embodiment, the leafhopper is a sharpshooter. Sharpshooters are leafhoppers in the tribes Proconiini and Cicadellini within the family Cicadellidae in the suborder Auchenorrhyncha of the Hemiptera. Examples of sharpshooters that may be controlled in accordance with the method of the invention include, but are not limited to, GWSS (Homalodisca coagulate), Homalodisca insolita, speckled sharpshooter (Paraulacizes irrorata), southeastern grass leafhopper (Cuerna costalis), Oncometopia nigricans, redheaded sharpshooter (Carneocephala fulgida), green sharpshooter (Draeculacephala minerva), blue-green sharpshooter (Graphocephala atropunctata), willow sharpshooter (G. confluens), and smoketree sharpshooter (previously Homalodisca lacerta; now Phera lacerta). Leafhopper vectors species known to be important in California, for example, include Carneocephala fulgida, Draeculacephala Minerva, Graphocephala atropunctata, G. confluens, and Phera lacerta.

The method of the present invention is particularly useful for controlling the genera of leafhoppers that are known or suspected of vectoring plant diseases. These pests are members of the order Hemiptera, family Cicadellidae, subfamily Cicadellinae and tribe Proconini. Examples of these pests include, but are not limited to, Carneocephala spp., Draeculacephala spp., Homalodisca spp., Hortensia spp., Oncometopia spp., Paraulacizes spp., Phera spp., Plesiommata spp., Plummerella spp., Sibovia spp., and Tylozygus spp. Examples of such pests that cause citrus variegated chlorosis/coffee leafscorch in regions such as Brazil include Diloboperus costalimai, Oncometopia facialis, Homalodisca ignorata, Acrogonia virescens, Molomea cincta, and Teletusa limpida. Examples of such pests that cause leafscorches of oak, elm, sycamore, and other trees in regions such as the mid-Atlantic states include Alebra albostriella, Edwardsiana rosae, Graphocephala spp., Oncometopia spp., Aulacizes irrorata, G. coccinea, G. versuta, O. undata, Erythroneura spp., and Typhlocybia spp.

The method of the present invention may also be used for controlling the genera of treehoppers (members of the family Membracidae) that are known or suspected of vectoring plant diseases. Examples of these pests include Enchenopa binotata, Ophiderma spp. (such as Ophiderma flavicephala, Ophiderma pubescens, Ophiderma evelyna, and Ophiderma flava), Cyrtolobus spp. (such as Cyrtolobus fenestratus), Archasia spp. (such as Archasia belfragei), Telanoma spp. (such as Telanoma ampelopsosis and Telanoma decorate), Glossonotus spp. (such as Glossonotus acuminatus), and Smilia camelus.

As used herein, the term “pesticidally effective” is used to indicate an amount or concentration of a pesticidal compound, such as a JH analog, that is sufficient to reduce the number of pests in a geographical locus as compared to a corresponding geographical locus in the absence of the amount or concentration of the pesticidal compound.

The term “pesticidal” is not intended to refer only to the ability to kill pests, but also includes the ability to interfere with a pest's life cycle in any way that results in an overall reduction in the pest population. For example, the term “pesticidal” includes inhibition of a pest from progressing from one form to a more mature form, e.g., transition between various larval instars or transition from larva to pupa or pupa to adult. Further, the term “pesticidal” is includes reduction of oviposition (including partial or complete elimination of oviposition). Further, the term “pesticidal” is intended to encompass anti-pest activity during all phases of a pest's life cycle; thus, for example, the term includes larvacidal, ovicidal, and adulticidal activity.

“Control” of the target pest (leafhoppers, such as GWSS, or treehoppers) can be a result of, for example, exposing a target pest to a bait/insecticidal composition so that the target pest ingests or otherwise contacts the composition. Control of the pest can take the form of killing the pest (immediately or prematurely), making the pest “sick” (to an adequate extent so that effective control of the pest is achieved), interfering with (preventing or delaying) oviposition of female pests, or otherwise interfering with (preventing or delaying) damage to the host plant by the pest. The term “pest” is intended to include any leafhopper or treehopper species, in any life stage, wherein their control is desired.

In accordance with the methods of the invention, the JH analog can be applied to any part of a plant, such as stem, leaves (e.g., on the upper and/or underside), flowers, roots, fruit, bark, shoots, branches, etc. The JH analog can be applied to the leafhopper or treehopper pest at any stage of development including, for example, neonates, nymphs, juveniles, and adults. The JH analog can applied continuously or in discrete increments. The JH analog can be applied once or multiple times.

In one embodiment, the method of the invention comprises applying the JH analog to a vineyard, in which case, the leafhopper may be present in a grape vine or the leafhopper-inhabited locus may be a grapevine.

The JH analog may be applied before or after leafhopper or treehopper infestation has occurred. The JH analog may be applied before or after feeding damage caused by the leafhopper or treehopper is evident on the host species. The JH analog may be applied before or after host species become symptomatic of a disease caused by the leafhopper or treehopper (e.g., caused by the bacterium Xylella fastidiosa), such as Pierce's disease, almond leaf scorch, phoney peach disease, alfalfa dwarf, oleander leaf scorch, citrus variegated chlorosis, and so on.

Optionally, the method of the invention further comprises verifying the presence of leafhopper or treehopper pests at the pest-inhabited locus, wherein verification is carried out before, during, and/or after applying the JH analog. This can be done by visual examination, e.g., by observing the pest itself or identifying evidence of its presence, such as plant damage. Leafhoppers feed on shoots and leaves by puncturing cells and sucking out contents. Feeding damage can appear as white spots or stippling. Leaves that are heavily damaged typically lose their color, dry up, and fall off. Monitoring can be carried out by counting the adults or nymphs (crawlers), which are young leafhoppers that cannot fly. Sampling can be conducted, for example, by inspecting plant parts (such as stems, leaves, and shoots), making use of yellow sticky traps (Heinz K. M., J. Econ. Entomol., 1992, 85(6):2263-2269), and/or using a sweep (butterfly) net in strategic areas of the canopy. Leafhopper pressure in a field can be evaluated by sweeping the field, which dislodges the leafhoppers from the plant and deposits them in the net. Counting the number of leafhoppers captured allows the farm manager to make a management decision. Scouting procedures and economic thresholds for leafhopper and treehopper pests are known to those skilled in the art.

For example, in the case of vineyards, nymphs can be counted on 15 to 20 leaves for a vineyard block (40 acres or less), and the average nymphs per leaf calculated. Leafhopper nymphs should be counted on both sides of the leaf. In addition to monitoring leafhopper nymphs, it may be useful to estimate damage of a vine's canopy during the season. Action levels may depend, for example, on nymphal population per leaf or percent canopy damage, and can be determined by those skilled in the art. For raisin and wine grapes, damage to leaves primarily occurs after July; therefore, it is important to monitor leafhoppers and vine damage beginning early July. Preferably, treatment should occur before a significant number of nymphs have emerged as adults. Adults are more destructive due to their mobility. Spotting of berries from leafhopper excrement is a primary concern with table grapes; therefore, the action level may be lower.

The present invention includes the use of agents or treatments in conjunction with JH analogs. For example, agents such as insecticides, bacteriocides, herbicides, and fungicides can be applied simultaneously or consecutively with the JH analogs, within the same or different formulations. Such agents may be chemical compounds, or naturally occurring or genetically modified microorganisms, for example, such as those described in Godfrey, L. D. et al., California Agriculture, January-March, 2005, 59(1):35-40. The present invention includes the use of JH analogs either alone as the active ingredient, or in combination with other compounds that can improve the efficacy or ease of the treatment. In accordance with the present invention, the compositions for use in controlling leafhoppers include mixtures such as a mixture of a JH analog in an effective amount and, for example, a protein hydrolysate bait or any synthetic bait to generate a bait or lure in the form of a patty, heavy cream, pellet, gel, foam, paste, liquid or spray. The bait or lure may be in the free form or, alternatively, in a form, such as granules or tablets, agglomerated with or without the aid of a binder. Moreover, the bait or lure can be fixed or impregnated on a support or absorbed therein, and this support may include for instance, agar, paper, cardboard, plastic such as polystyrene, polyvinyl chloride, polyvinyl acetate and cellulose acetate, glass, pumice, crushed marble, silica or silica minerals. Optionally, toxicants can be used in conjunction with the JH analog application.

The control method and composition of the subject invention may incorporate one or more agents or treatments that contribute to the control of the treehopper or leafhopper pest. For example, the control method of the invention may further comprise exposing/introducing a predator or parasite, such as a wasp, to the treehopper or leafhopper pest or pest-inhabited locus. The predator or parasite may be native or non-native to the geographic area. The control method of the invention may include the application of mulch, such as wheat straw mulch, to the pest-inhabited locus (Summers C. G., UC Plant Protection Quarterly, July, 2003, pp. 1-4). The control method and composition of the subject invention may incorporate kaolin-based agents (such as SURROUND; ENGELHARD Corporation, Iselin, N.J.) and hydrophobic or hydrophilic particulate films, such as those described in U.S. Pat. Nos. 6,514,512; 6,464,995; 6,235,683; 6,156,327; 6,110,867; 6,069,112; 6,060,521; 6,027,740; and 5,908,708; U.S. patent publications 20040220056 and 20030077309; Unruh T. R. et al., J. Econ. Entomol., 2000, 93(3):737-743; Puterka G. et al., Environ. Entomol., 2000, 29(2):329-339; Glenn D. M. et al., J. Econ. Entomol., 1999, 92(4):759-771; Lalancette N. et al., January, 2005, Pest Management Science, 61(1):25-39; Jifon J. L. and Syversten J. P., J. Amer. Soc. Hort. Sci., 2003, 128(1):107-112; and Pasqualini E. et al., Bulletin of Insectology, 55(1-2):39-42. Kaolin, which is the basis for many particle film formulations such as SURROUND, is a white, non-abrasive, inert aluminosilicate mineral (Al₄Si₄O₁₀[OH]₈) that is widely used in a variety of industrial applications including in paints, cosmetics, and pharmaceuticals (Dean, L., “Feature film new technology creates barrier”, Gt. Lakes Fruit Grower News 37). The United States Department of Agriculture (USDA-ARS) and ENGELHARD Corp. formed a partnership to develop both hydrophobic and hydrophilic particle films for use in agriculture. Kaolin particles can be coated with chrome complexes, stearic acid, organic zirconate, or other materials to make them hydrophobic. Kaolin formulations may be applied in various forms such as dust or solutions. Plants coated with a hydrophobic particle film barrier can become visually or tactilely unrecognizable as a host to the pest. Pest movement, feeding, oviposition, and other activities can also be severely impaired by the attachment of particles to the bodies of the pest as they crawl upon the film. SURROUND is a kaolin-based non-insecticidal hydrophobic mineral particle film that acts as a physical barrier protecting plants against certain insects and diseases.

Furthermore, attractants, such as sweeteners, carriers and/or liquefiers may be used together with the JH analog. A bait or lure may be placed in selected locations such that the leafhoppers are likely to encounter and contact and, optionally, ingest the JH analog to achieve the desired effect, but preferably out of the way of normal human or animal traffic.

One embodiment of the present invention pertains to the use of a JH analog or JH analog-containing composition in wide-area suppression and eradication programs.

A second innovative method for use in accordance with this invention is to formulate the JH analog with an extender or gel. In this case, gels can be sprayed in a solid stream to adhere to tree trunks, telephone poles, buildings and so forth. The gels are formulated with synthetic bait and/or natural proteinaceous baits. This method of application reduces worker and public inconvenience of aerial spraying of large areas. For the homeowner, either the gel formulation or the liquid formulation may be applied to individual host trees for leafhopper control.

It should, of course, be understood by those versed in this art that the compositions of the present invention may be applied by any suitable means, such as by pressurized applications, hydraulic oil squirt cans and aerial sprays.

Formulated bait granules containing an attractant and the JH analog can be applied to a pest-inhabited locus, such as plants and/or the soil. Formulated product can also be applied as a seed-coating or root treatment or total plant treatment at later stages of the crop cycle. Plant and soil treatments may be employed as wettable powders, granules or dusts, by mixing with various inert materials, such as inorganic minerals (phyllosilicates, carbonates, sulfates, phosphates, and the like) or botanical materials (powdered corncobs, rice hulls, walnut shells, and the like). The formulations may include spreader-sticker adjuvants (such as NATUR'L OIL), stabilizing agents, other pesticidal additives, or surfactants. Liquid formulations may be aqueous-based or non-aqueous and employed as foams, gels, suspensions, emulsifiable concentrates or the like. The ingredients may include rheological agents, surfactants, emulsifiers, dispersants or polymers.

As would be appreciated by a person skilled in the art, the pesticidal concentration will vary widely depending upon the nature of the particular formulation, particularly whether it is a concentrate or to be used directly. The pesticide will be present in at least about 0.0001% by weight and may be 100% by weight. The dry formulations will have from about 0.0001-95% by weight of the pesticide while the liquid formulations will generally be from about 0.0001-60% by weight of the solids in the liquid phase.

The formulations can be applied to the environment of the pest, e.g., soil and foliage, by spraying, dusting, sprinkling or the like.

GWSS host species are listed in Table 1. Any of the listed host species may be a leafhopper-inhabited locus in accordance with the control method of the present invention.

TABLE 1
Glassy-winged sharpshooter host species.

| Common Name | Scientific Name |
|---|---|
| Abelia | Abelia spp. |
| Acacia | Acacia spp. |
| Agapanthus | Agapanthus spp. |
| Albizzia | Albizia spp. |
| Alder | Alnus spp. |
| Aleurites | Aleurites spp. |
| Amaranth | Amaranthus spp. |
| Ananas | Ananas spp. |
| Annona (cherimoya) | Annona spp. |
| Apple | Malus spp. |
| Aptenia | Aptenia spp. |
| Aralia ivy | Fatshedera spp. |
| Arborvitae | Thuja spp. |
| Arecastrum | Arecastrum spp. |
| Arizona rosewood | Vauquelinia spp. |
| Ash | Fraxinus spp. |
| Asparagus | Asparagus spp. |
| Aspidistra | Aspidistra spp. |
| Avocado | Persea spp. |
| Azalea | Rhododendron spp. |
| Baccharis | Baccharis spp. |
| Barberry | Berberis spp. |
| Basket plant | Aeschynanthus spp. |
| Bauhinia | Bauhinia spp. |
| Beard-tongue | Penstemon spp. |
| Bignonia | Bignonia spp. |
| Birch | Betula spp. |
| Bird of paradise | Strelitzia spp. |
| Blackberry | Rubus spp. |
| Boneset | Eupatorium spp. |
| Bottle tree | Brachychiton spp. |
| Bottlebrush | Callistemon spp. |
| Bougainvillea | Bougainvillea spp. |
| Boxwood | Buxus spp. |
| Brunfelsia | Brunfelsia spp. |
| Buckthorn | Rhamnus spp. |
| Bugleweed | Ajuga spp. |
| Cactus | Opuntia spp. |
| Calla lily | Zantedeschia spp. |
| Camellia | Camellia spp |
| Canna | Canna spp. |
| Cape chestnut | Calodendrum spp. |
| Carob | Ceratonia spp. |
| Castanospermum | Castanospermum spp. |
| Feijoa | Feijoa spp. |
| Fig | Forsythia spp. |
| Fishtail | Caryota spp. |
| Flax lily | Phormium spp. |
| Fleabane | Erigeron spp. |
| Floss-silk tree | Chorisia spp. |
| Fringe tree | Chionanthus spp. |
| Frogfruit | Phyla spp. |
| Gardenia | Gardenia spp. |
| Gazania | Gazania spp. |
| Geijera | Geijera spp. |
| Gingko | Ginkgo spp. |
| Gladiolus | Gladiolus spp. |
| Golden-bells | Ficus spp. |
| Golden-rain tree | Koelreuteria spp. |
| Goldenrod | Solidago spp. |
| Grape | Vitis spp. |
| Grape ivy | Cissus spp. |
| Green ebony | Jacaranda spp. |
| Grewia spp | Grewia spp. |
| Guava | Psidium spp. |
| Hardenbergia | Hardenbergia spp. |
| Hibiscus | Hibiscus spp. |
| Holly | Ilex spp. |
| Hollyhock | Althaea spp. |
| Honey myrtle | Melaleuca spp. |
| Honeysuckle | Lonicera spp. |
| Hymenosporum | Hymenosporum spp. |
| Itea | Itea spp. |
| Ivy | Hedera spp. |
| Jasmine | Jasminum spp. |
| Jojoba | Simmondsia spp. |
| Kaffir plum | Harpephyllum spp. |
| Kumquat | Fortunella spp. |
| Lambsquarter | Chenopodium spp. |
| Laurel | Laurus spp. |
| Leadwort | Plumbago spp. |
| Lettuce | Lactuca spp. |
| Lilac | Syringa spp. |
| Lippia | Lippia spp. |
| Locust | Robinia spp. |
| Loropetalum | Loropetalum spp. |
| Lychee | Litchi spp. |
| Macadamia | Macadamia spp. |
| Privet | Ligustrum spp. |
| Protea | Protea spp. |
| Prunus | Prunus spp. |
| Pyracantha/Firethorn | Pyracantha spp. |
| Queen Palm | Arecastrum (Syagrus)spp. |
| Ragweed | Ambrosia spp. |
| Raphiolepis | Raphiolepis spp. |
| Redbud | Cercis spp. |
| Redroot | Ceanothus spp. |
| Rock rose | Cistus spp. |
| Rose | Rosa spp. |
| Sapium | Sapium spp |
| Sassafras | Sassafras spp. |
| Schinus | Schinus spp. |
| Seaforthia | Archontophoenix spp. |
| Senna | Cassia spp. |
| Sentry palm | Howea spp. |
| Serviceberry | Amelanchier spp. |
| Shrub verbena | Lantana spp. |
| Snapdragon | Antirrhinum spp |
| Solanum | Solanum spp. |
| Sonchus | Sonchus spp. |
| Sorghum | Sorghum spp. |
| Speedwell | Veronica spp. |
| Spider flower | Grevillea spp. |
| Spiderwort | Tradescantia spp. |
| Spurge | Pachysandra spp. |
| St. Bernard's lily | Chlorophytum spp. |
| St. John's-wort | Hypericum spp. |
| Staghorn fern | Platycerium spp. |
| Statice | Limonium spp. |
| Strawberry tree | Arbutus spp. |
| Sumac | Rhus spp. |
| Sunflower | Helianthus spp. |
| Sweet box | Sarcocca spp. |
| Catawba | Catalpa spp. |
| Ceratostigma | Ceratostigma spp. |
| Champak | Michelia spp. |
| Chinaberry | Melia spp. |
| Chinquapin | Castanopsis spp. |
| Chitalpa | Chitalpa spp. |
| Chokecherry | Aronia spp. |
| Christmas cacuts | Schlumbergera spp. |
| Chrysanthemum | Chrysanthemum spp. |
| Cinnamomum | Cinnamomum spp. |
| Citrus | Citrus spp. |
| Clytostoma | Clytostoma spp. |
| Cocculus | Cocculus spp. |
| Cocklebur | Xanthium spp. |
| Cocos | Cocos spp. |
| Coffee | Coffea spp. |
| Coneflower | Rudbeckia spp. |
| Coprosma | Coprosma spp. |
| Coral tree | Erythrina spp. |
| Cotoneaster | Cotoneaster spp. |
| Cotton | Gossypium spp. |
| Cottonwood | Populus spp. |
| Crape myrtle | Lagerstroemia spp. |
| Crassula | Crassula spp. |
| Cupaniopsis | Cupaniopsis spp. |
| Cycad | Cycas spp. |
| Date palm | Phoenix spp. |
| Daylily | Hemerocallis spp. |
| Dianthus | Dianthus spp. |
| Dietes | Dietes spp. |
| Dodonaea | Dodonaea spp. |
| Dogwood | Cornus spp. |
| Elaeagnus | Elaeagnus spp. |
| Elaeocarpus | Elaeocarpus spp. |
| Elderberry | Sambucus spp. |
| Elm | Ulmus spp. |
| Ensete | Ensete spp. |
| Eriobotrya | Eriobotrya spp. |
| Escallonia | Escallonia spp. |
| Eucalyptus | Eucalyptus spp. |
| Eugenia | Eugenia spp. |
| Euonymus | Euonymus spp. |
| Euryops | Euryops spp. |
| Evening primrose | Oenothera spp. |
| Magnolia | Magnolia spp. |
| Mallow | Malva spp. |
| Mandevilla | Mandevilla spp. |
| Mango | Mangifera spp. |
| Manzanita | Arctostaphylos spp. |
| Maytenus | Maytenus spp. |
| Metrosideros | Metrosideros spp. |
| Milkweed | Asclepias spp. |
| Milkwort | Polygala spp. |
| Mock orange | Philadelphus spp. |
| Mountain ash | Sorbus spp. |
| Mountain mahogany | Cercocarpus spp. |
| Mulberry | Morus spp. |
| Myoporum | Myoporum spp. |
| Myrsine | Myrsine spp. |
| Myrtle | Myrtus spp. |
| Nandina | Nandina spp. |
| Oak | Quercus spp. |
| Oleander | Nerium spp. |
| Olive | Olea spp. |
| Orange jessamine | Murraya spp. |
| Osmanthus | Osmanthus spp. |
| Osteospermum | Osteospermum spp. |
| Palo Verde | Cercidium spp. |
| Pandorea | Pandorea spp. |
| Papaya | Carica spp. |
| Passion fruit | Passiflora spp. |
| Pear | Pyrus spp. |
| Pelargonium | Pelargonium spp. |
| Pepper, chile | Capsicum spp. |
| Periwinkle | Vinca spp. |
| Persimmon | Diospyros spp. |
| Philodendron | Philodendron spp. |
| Phlox | Phlox spp. |
| Photinia | Photinia spp. |
| Pine | Pinus spp. |
| Pistachio | Pistacia spp. |
| Sweet gum | Liquidambar spp. |
| Sword fern | Nephrolepis spp. |
| Sycamore | Platanus spp. |
| Syzygium | Syzygium spp. |
| Tecomaria | Tecomaria spp. |
| Ternstroemia | Ternstroemia spp. |
| Ti | Cordyline spp. |
| Tipu Tree | Tipuana spp. |
| Toyon | Heteromeles spp. |
| Pittosporum | Pittosporum spp. |
| Podocarpus | Podocarpus spp. |
| Pokeweed | Phytolacca spp. |
| Polygonum | Polygonum spp. |
| Pomegranate | Punica spp. |
| Portulacaria | Portulacaria spp. |
| Powderpuff | Calliandra spp. |
| Trachelospermum | Trachelospermum spp. |
| Tree tobacco | Nicotiana spp. |
| Tristania | Tristania spp. |
| Trumpet creeper | Campsis spp. |
| Trumpet tree | Tabebuia spp. |
| Tulbaghia | Tulbaghia spp. |
| Tulip tree | Liriodendron spp. |
| Tupelo | Nyssa spp. |
| Tupidanthus | Tupidanthus spp. |
| Umbrella tree | Schefflera spp. |
| Umbrella wort | Mirabilis spp. |
| Viburnum | Viburnum spp. |
| Vigna | Vigna spp. |
| Violet | Viola spp. |
| Walnut | Juglans spp. |
| Washington palm | Washingtonia spp. |
| Wild bergamot | Monarda spp. |
| Willow | Salix spp. |
| Willow myrtle | Agonis spp. |
| Wisteria | Wisteria spp. |
| Woodbine | Parthenocissus spp. |
| Xylosma | Xylosma spp. |
| Yellow jessamine | Gelsemium spp. |
| Yucca | Yucca spp. |
| Zea | Zea spp. |

In addition to one or more JH analogs, the control methods and pesticidal compositions of the present invention may incorporate or include one or more other insecticides including, but not limited to, antibiotic insecticides, such as, allosamidin or thuringiensin; macrocyclic lactone insecticides, such as, spinosad; avermectin insecticides, such as, abamectin, doramectin, emamectin, eprinomectin, ivermectin, or selamectin; milbemycin insecticides, such as, lepimectin, milbemectin, milbemycin oxime, or moxidectin; arsenical insecticides, such as, calcium arsenate, copper acetoarsenite, copper arsenate, lead arsenate, potassium arsenite, or sodium arsenite; botanical insecticides, such as, anabasine, azadirachtin, d-limonene, nicotine, pyrethrins, cinerins, cinerin I, cinerin II, jasmolin I, jasmolin II, pyrethrin I, pyrethrin II, quassia, rotenone, ryania, or sabadilla; carbamate insecticides, such as, bendiocarb or carbaryl; benzofuranyl methylcarbamate insecticides, such as, benfuracarb, carbofuran, carbosulfan, decarbofuran, or furathiocarb; dimethylcarbamate insecticides, such as, dimetan, dimetilan, hyquincarb, or pirimicarb; oxime carbamate insecticides, such as, alanycarb, aldicarb, aldoxycarb, butocarboxim, butoxycarboxim, methomyl, nitrilacarb, oxamyl, tazimcarb, thiocarboxime, thiodicarb, or thiofanox; phenyl methylcarbamate insecticides, such as, allyxycarb, aminocarb, bufencarb, butacarb, carbanolate, cloethocarb, dicresyl, dioxacarb, EMPC, ethiofencarb, fenethacarb, fenobucarb, isoprocarb, methiocarb, metolcarb, mexacarbate, promacyl, promecarb, propoxur, trimethacarb, XMC, or xylylcarb; dinitrophenol insecticides, such as, dinex, dinoprop, dinosam, or DNOC; fluorine insecticides, such as, barium hexafluorosilicate, cryolite, sodium fluoride, sodium hexafluorosilicate, or sulfluramid; formamidine insecticides, such as, amitraz, chlordimeform, formetanate, or formparanate; fumigant insecticides, such as, acrylonitrile, carbon disulfide, carbon tetrachloride, chloroform, chloropicrin, para-dichlorobenzene, 1,2-dichloropropane, ethyl formate, ethylene dibromide, ethylene dichloride, ethylene oxide, hydrogen cyamide, iodomethane, methyl bromide, methylchloroform, methylene chloride, naphthalene, phosphine, sulfuryl fluoride, or tetrachloroethane; inorganic insecticides, such as, borax, calcium polysulfide, copper oleate, mercurous chloride, potassium thiocyanate, or sodium thiocyanate; insect growth regulators; chitin synthesis inhibitors, such as, bistrifluoron, buprofezin, chlorfluazuron, cyromazine, diflubenzuron, flucycloxuron, flufenoxuron, hexaflumuron, lufenuron, novaluron, noviflumuron, penfluoron, teflubenzuron, or triflumuron; juvenile hormone mimics, such as, epofenonane, fenoxycarb, hydroprene, kinoprene, methoprene, pyriproxyfen, or triprene; juvenile hormones, such as, juvenile hormone I, juvenile hormone II, or juvenile hormone III; moulting hormone agonists, such as, chromafenozide, halofenozide, methoxyfenozide, or tebufenozide; moulting hormones, such as, α-ecdysone or ecdysterone; moulting inhibitors, such as, diofenolan; precocenes, such as, precocene I, precocene II, or precocene III; unclassified insect growth regulators, such as, dicyclanil; nereistoxin analogue insecticides, such as, bensultap, cartap, thiocyclam, or thiosultap; nicotinoid insecticides, such as, flonicamid; nitroguanidine insecticides, such as, clothianidin, dinotefuran, imidacloprid, or thiamethoxam; nitromethylene insecticides, such as, nitenpyram or nithiazine; pyridylmethylamine insecticides, such as, acetamiprid, imidacloprid, nitenpyram, or thiacloprid; organochlorine insecticides, such as, bromo-DDT, camphechlor, DDT, pp′-DDT, ethyl-DDD, HCH, gamma-HCH, lindane, methoxychlor, pentachlorophenol, or TDE; cyclodiene insecticides, such as, aldrin, bromocyclen, chlorbicyclen, chlordane, chlordecone, dieldrin, dilor, endosulfan, endrin, HEOD, heptachlor, HHDN, isobenzan, isodrin, kelevan, or mirex; organophosphorus insecticides; organophosphate insecticides, such as, bromfenvinfos, chlorfenvinphos, crotoxyphos, dichlorvos, dicrotophos, dimethylvinphos, fospirate, heptenophos, methocrotophos, mevinphos, monocrotophos, naled, naftalofos, phosphamidon, propaphos, TEPP, or tetrachlorvinphos; organothiophosphate insecticides, such as, dioxabenzofos, fosmethilan, or phenthoate; aliphatic organothiophosphate insecticides, such as, acethion, amiton, cadusafos, chlorethoxyfos, chlormephos, demephion, demephion-O, demephion-S, demeton, demeton-O, demeton-S, demeton-methyl, demeton-O-methyl, demeton-5-methyl, demeton-5-methylsulphon, disulfoton, ethion, ethoprophos, IPSP, isothioate, malathion, methacrifos, oxydemeton-methyl, oxydeprofos, oxydisulfoton, phorate, sulfotep, terbufos, or thiometon; aliphatic amide organothiophosphate insecticides, such as, amidithion, cyanthoate, dimethoate, ethoate-methyl, formothion, mecarbam, omethoate, prothoate, sophamide, or vamidothion; oxime organothiophosphate insecticides, such as, chlorphoxim, phoxim, or phoxim-methyl; heterocyclic organothiophosphate insecticides, such as, azamethiphos, coumaphos, coumithoate, dioxathion, endothion, menazon, morphothion, phosalone, pyraclofos, pyridaphenthion, or quinothion; benzothiopyran organothiophosphate insecticides, such as, dithicrofos or thicrofos; benzotriazine organothiophosphate insecticides, such as, azinphos-ethyl or azinphos-methyl; isoindole organothiophosphate insecticides, such as, dialifos or phosmet; isoxazole organothiophosphate insecticides, such as, isoxathion or zolaprofos; pyrazolopyrimidine organothiophosphate insecticides, such as, chlorprazophos or pyrazophos; pyridine organothiophosphate insecticides, such as, chlorpyrifos or chlorpyrifos-methyl; pyrimidine organothiophosphate insecticides, such as, butathiofos, diazinon, etrimfos, lirimfos, pirimiphos-ethyl, pirimiphos-methyl, primidophos, pyrimitate, or tebupirimfos; quinoxaline organothiophosphate insecticides, such as, quinalphos or quinalphos-methyl; thiadiazole organothiophosphate insecticides, such as, athidathion, lythidathion, methidathion, or prothidathion; triazole organothiophosphate insecticides, such as, isazofos or triazophos; phenyl organothiophosphate insecticides, such as, azothoate, bromophos, bromophos-ethyl, carbophenothion, chlorthiophos, cyanophos, cythioate, dicapthon, dichlofenthion, etaphos, famphur, fenchlorphos, fenitrothion, fensulfothion, fenthion, fenthion-ethyl, heterophos, jodfenphos, mesulfenfos, parathion, parathion-methyl, phenkapton, phosnichlor, profenofos, prothiofos, sulprofos, temephos, trichlormetaphos-3, or trifenofos; phosphonate insecticides, such as, butonate or trichlorfon; phosphonothioate insecticides, such as, mecarphon; phenyl ethylphosphonothioate insecticides, such as, fonofos or trichloronat; phenyl phenylphosphonothioate insecticides, such as, cyanofenphos, EPN, or leptophos; phosphoramidate insecticides, such as, crufomate, fenamiphos, fosthietan, mephosfolan, phosfolan, or pirimetaphos; phosphoramidothioate insecticides, such as, acephate, isocarbophos, isofenphos, methamidophos, or propetamphos; phosphorodiamide insecticides, such as, dimefox, mazidox, mipafox, or schradan; oxadiazine insecticides, such as, indoxacarb; phthalimide insecticides, such as, dialifos, phosmet, or tetramethrin; pyrazole insecticides, such as, acetoprole, ethiprole, fipronil, pyrafluprole, pyriprole, tebufenpyrad, tolfenpyrad, or vaniliprole; pyrethroid insecticides; pyrethroid ester insecticides, such as, acrinathrin, allethrin, bioallethrin, barthrin, bifenthrin, bioethanomethrin, cyclethrin, cycloprothrin, cyfluthrin, beta-cyfluthrin, cyhalothrin, gamma-cyhalothrin, lambda-cyhalothrin, cypermethrin, alpha-cypermethrin, beta-cypermethrin, theta-cypermethrin, zeta-cypermethrin, cyphenothrin, deltamethrin, dimefluthrin, dimethrin, empenthrin, fenfluthrin, fenpirithrin, fenpropathrin, fenvalerate, esfenvalerate, flucythrinate, fluvalinate, tau-fluvalinate, furethrin, imiprothrin, metofluthrin, permethrin, biopermethrin, transpermethrin, phenothrin, prallethrin, profluthrin, pyresmethrin, resmethrin, bioresmethrin, cismethrin, tefluthrin, terallethrin, tetramethrin, tralomethrin, or transfluthrin; pyrethroid ether insecticides, such as, etofenprox, flufenprox, halfenprox, protrifenbute, or silafluofen; pyrimidinamine insecticides, such as, flufenerim or pyrimidifen; pyrrole insecticides, such as, chlorfenapyr; tetronic acid insecticides, such as, spiromesifen or spirotetramat; thiourea insecticides, such as, diafenthiuron; urea insecticides, such as, flucofuron or sulcofuron; unclassified insecticides, such as, closantel, crotamiton, EXD, fenazaflor, fenoxacrim, flubendiamide, hydramethylnon, isoprothiolane, malonoben, metaflumizone, metoxadiazone, nifluridide, pyridaben, pyridalyl, rafoxanide, triarathene, or triazamate.

Pesticidal compositions of the invention comprise mixtures or solutions containing at least one JH analog. The pesticidal compounds of the invention can be used alone or in combination.

Pesticidal compositions of the invention may also contain carriers or diluents. A carrier or diluent is an inert material used in making different formulations of pesticidal compounds. The specific carrier used in any pesticidal composition depends on the pest it is meant to eradicate, how the pesticidal composition will be applied (whether in a spray or dust form for example) and where the pesticidal composition will be applied.

There are a number of different general classes of pesticide formulations, including for example sprays, dusts, granules, and aerosols.

Spray formulations include aqueous solutions, water-soluble powders, emulsifiable concentrates, water miscible liquids/powders (for pesticidal compounds that are soluble in water), wettable powders or water-dispersible powders, flowable/sprayable suspensions or suspension concentrates, and oil solutions. Although sprays are a very popular method of applying pesticides, only a small number of pesticides are sufficiently soluble in water to be formulated into an aqueous solution, water-soluble powder, or water miscible liquid or powder. Therefore, most spray formulations require an organic solvent or a specialized formulation to enable them to be mixed with water for spray application.

A spray formulation that may be used for the invention is an emulsifiable concentrate. In an emulsifiable concentrate, a concentrated organic solvent based solution of the JH analog (or the JH analog alone if it is a liquid at room temperature) is added to an emulsifier. An emulsifier is a detergent-like (surfactant) material that allows microscopically small oil droplets to be suspended in water to form an emulsion. The concentrate is thereby dispersed evenly throughout an aqueous solution and generally remains suspended for an extended period of time (days).

Emulsifiers useful in the invention include Tween 200, Tween 600, sorbitol (polysorbate 80), propylene glycol, polyethylene glycol, ethanol (ethyl alcohol) and methanol (methyl alcohol). Another type of surfactant that can be used as an emulsifier for pesticide formulations is the phosphate esters. Examples of commercially available phosphate ester surfactants include: butyl phosphate, hexyl phosphate, 2-ethylhexyl phosphate, octyl phosphate, decyl phosphate, octyldecyl phosphate, mixed alkyl phosphate, hexyl polyphosphate, and octyl polyphosphate. Preferably, the emulsifier used is either Tween 200, sorbitol 80, propylene glycol, polyethylene glycol, or ethyl alcohol. More preferably, sorbitol 80 is used as the emulsifier if an emulsifiable concentrate of a compound of the invention is to be formulated.

Wettable powders or water-dispersible powders are also a potential spray formulation. Wettable powders are made by mixing the JH analog with a fine dust (generally clay or talc) and a wetting agent (a dry soap or detergent). This mixture is then dispersed in water before spraying. The wetting agent will act as an emulsifier in the aqueous solution and cause any insoluble compound in the formulation to dissolve in water. Emulsifiable concentrates are preferred over wettable powders for most applications because the wettable powder aqueous solution will tend to “settle” quickly, while requiring agitation in order to keep a constant concentration of pesticidal compound while spraying.

Flowable/sprayable suspensions or suspension concentrates are another method of creating a spray formulation with a pesticidal compound that is insoluble in water. A flowable/sprayable suspension is a suspension of very finely ground dust diluent and pesticidal compound in a non-solvent liquid (generally water). The suspension will then mix well with water and can be sprayed. Flowable/sprayable suspensions suffer the same disadvantage as wettable powders because they tend to “settle” out and give varying concentrations of pesticidal compound throughout spraying.

An oil solution is another method of creating a spray formulation with a pesticidal compound that is insoluble in water. The pesticidal compound is dispersed in oil and applied as an oil-based spray. This formulation is convenient for ready-to-use pesticides where further handling by the user is not desired.

The concentration of pesticidal compounds (JH analogs) in spray formulations ranges from 0.1% to 15% by weight. Preferably, the concentration of pesticidal compounds in spray formulations ranges from 0.5 to 10% by weight. More preferably, the concentration of pesticidal compounds in spray formulations ranges from 0.75% to 7.5% by weight.

In a dust formulation, the JH analog is mixed with a solid particulate diluent (preferably one with a size range of 50-100 μm). The dust formulation is then mixed with the air through the aid of a dusting machine. Although dust formulations have historically been the easiest to make and apply, application rates, and pesticidal compound concentrations have to be exceedingly high. Further, even though the amount of pesticidal compound applied is very high, the actual amount of the pesticidal compound that reaches the target is generally low because the dusts are prone to drift.

Dust formulations can be utilized in formulations of the pesticidal compounds of the present invention. Preferred diluents for use in dust formulations are silicon dioxide, zinc oxide, talc, diatomaceous earth, clays, calcium carbonate, wheat flour, and powdered nut hulls.

The concentration of pesticidal compounds in dust formulations ranges from 0.10 to 20% by weight. Preferred concentrations of pesticidal compounds in dust formulations ranges from 5 to 15% by weight. More preferably, the concentrations of pesticidal compounds in dust formulations ranges from 7 to 12% by weight.

The JH analogs can also be formulated into granular formulations. Granules are small pellets (usually 0.3-1.3 mm) of inert carrier (usually clay) mixed with the pesticidal compound to give the desired concentration. Granules can be formulated to allow a rapid release, or an extended release of the pesticidal compound over time. Granular formulations are useful for relatively small scale (garden or houseplant) applications, and in applications where safer handling is desired.

The concentration of JH analogs in granular formulations ranges from 0.1 to 20% by weight. Preferred concentrations range from 5 to 15% by weight. More preferably, the concentration of JH analogs in dust formulations ranges from 7 to 12% by weight.

The JH analogs can also be formulated into aerosol formulations. In order to use an aerosol formulation, the JH analog must be soluble in a pressurized, volatile, petroleum solvent. Upon application of the aerosol formulation, the solvent evaporates leaving micro-droplets of the pesticidal compound suspended in the air. Aerosol formulations are useful for indoor applications, or small scale outdoor applications.

The concentration of JH analog in aerosol formulations ranges from 0.1% to 15% by weight. Preferably, the concentration of JH analog in aerosol formulations ranges from 0.5 to 10% by weight. More preferably, the concentration of pesticidal compounds in aerosol formulations ranges from 0.75% to 7.5% by weight.

The formulated pesticidal composition can either be applied directly or can be diluted further before application. The diluent depends on the specific treatment to be accomplished, and the method of application. For example, a pesticidal composition that is to be applied to trees could be diluted further with water to make it easier and more efficient to spray with known spraying techniques. Preferably, the formulated pesticidal composition is diluted from 1:100 to 1:10 with water. More preferably, the pesticidal composition is diluted 1:10 with water.

Pesticidal compositions, either diluted or undiluted, can be applied in a number of different ways. For small scale application of a liquid pesticidal composition, backpack tanks, hand-held wands, spray bottles, or aerosol cans can be utilized. For somewhat larger scale application of liquid pesticidal compositions, tractor drawn rigs with booms, tractor drawn mist blowers, airplanes or helicopters equipped for spraying, or fogging sprayers can all be utilized. Small-scale application of solid formulations can be accomplished in a number of different ways, examples of which are: shaking product directly from the container or gravity-application by human powered fertilizer spreader. Large-scale application of solid formulations can be accomplished by gravity fed tractor drawn applicators, or similar devices.

As described in Examples 1 and 2, the inventors topically applied methoprene in an aqueous solution to GWSS females that were: 1) over-wintering in reproductive diapause or 2) females that were newly eclosed adults and not yet reproductively active. Diapausing females that were treated remained reproductively inactive for at least 30 days after they were placed into summer conditions (32° C., 14:10 L:D photoperiod) that caused the untreated control females to begin ovipositing after 10 days. Additionally, newly enclosed females did not develop eggs or oviposit after treatment with this chemical, even after 36 days of summer conditions. Untreated females ordinarily will begin reproductive cycles 10-12 days post eclosion. Treated reproductively-active females oviposited the eggs they contained then stopped for the following weeks of evaluation. Treating GWSS nymphs of stage with this material did not cause mortality, increase or decrease time of development, or induce morphological aberrations.

The present inventors quantified the efficacy of methoprene only after targeted dissection of the reproductive system of adult females. Methoprene inhibits the development of both brochosomes and ovarioles. Treated females have a high amount of accumulated fat body but do not produce eggs for at least 36 days post-treatment. Thirty-six days was the maximum amount of time tested, but greatly exceeds the 10-12 days after adult eclosion that normal GWSS females require after to begin oviposition.

The GWSS female reproductive cycle suggests that environmental conditions encountered by nymphs greatly impact subsequent oviposition as adults. Potentially, nymphal exposure to methoprene and other JH analogs may also impact adult fecundity. These effects would not be noted in the initial discovery screenings that were performed previously by researchers. With the exciting preliminary data shown in Examples 1 and 2, and the knowledge of the previous research on the myriad effects of JH analogs on an array of insects species, these compounds can be evaluated for their impact on the physiology and behavior of GWSS, its parasites, Gonatocerus spp, and for comparison purposes two related leafhopper species, Homalodisca insolita and Oncometopia nigricans. Tests will be conducted with the two related vectors to ascertain how broad the impacts of the IGRs may be on this group of insects so that extrapolation can be made to other vector species in and outside California.

The present state of knowledge on PD/GWSS suggests that solving the problem will require a long-term research effort focused on a variety of objectives aimed at the biology, behavior and interactions between the bacterium, the vector and the host plants. If a “silver bullet” is discovered it will likely be something that directly affects the bacterium. However, what areas will be most fruitful or the time frame necessary to develop and implement a primary solution is not predictable. At this time, during perhaps a transition of 5-10 years or longer, we must continue to address the problem from as many promising perspectives as possible including chemical, cultural and management methods for controlling the spread and establishment of the vector. There is no other way to preserve the multi-billion dollar industries that are affected by this potentially devastating problem during the transition period. The present invention offers a new approach that will impact the vector in several ways not currently being investigated by addressing egg deposition in nursery crops and the establishment of new colonies. Moreover, the tools are readily available, safe and environmentally benign.

The terms “comprising”, “consisting of” and “consisting essentially of” are defined according to their standard meaning. The terms may be substituted for one another throughout the instant application in order to attach the specific meaning associated with each term.

As used herein, the singular forms “a”, “an”, and “the” include plural reference unless the context clearly dictates otherwise. Thus, for example, a reference to “a JH analog” includes more than one such JH analog. A reference to “leafhopper” includes more than one such leafhopper, or species of leafhopper. A reference to “an agent” is used to refer to more than one such agent.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

### EXAMPLE 1

### Females in Diapause

Ten female Homalodisca coagulata (Say) were sprayed until visibly wet with the candidate compound. They were then placed into a wooden 1 m screened cage that was provisioned with five males and glabrous soybean, Glycine max (L.) A similar untreated control cage was also set up with females sprayed with distilled water. All leafhoppers were taken from a greenhouse culture and were in the process of terminating winter reproductive diapause. Females were checked daily for the presence of brochosomes and plants were checked for egg masses. Cages were in a greenhouse maintained at 32° C. and equipped with artificial lighting for a 14:10 photoperiod. Surviving females were dissected after thirty days and their reproductive status was evaluated.

No eggs were produced by any treated GWSS females. As shown in Table 2, dissections revealed that all surviving treated females had not begun reproductive activity, even after 30 days. There was little or no brochosome material in the Malpighian tubules and no development of ova. All control females were reproductively active.

TABLE 2
Status of reproductive structures of H. coagulata
females treated with compound.

| | Ovarioles | Fat body | Brochosomes | Ova |
|---|---|---|---|---|
| Treated | | | | |
| Female # | | | | |
| 1 | 2 | 2 | 1 | 1 |
| 2 | 2 | 2 | 1 | 1 |
| 3 | 2 | 2 | 1 | 1 |
| Untreated | | | | |
| Female # | | | | |
| 1 | 3 | 1 | 2.5 | 2 |
| 2 | 3 | 2 | 3 | 2 |
| 3 | 3 | 1.5 | 3 | 2 |
| 4 | 3 | 1.5 | 3 | 2 |
| 5 | 3 | 1.5 | 3 | 2 |
| 6 | 3 | 1.5 | 3 | 3 |

Key:
Ovarioles
1 = small, little development
2 = fully developed; no ova
3 = fully developed with ova
Ova
1 = none
2 = single developing ova per ovariole
3 = two or more developing ova per ovariole
Fat body
1 = minimal
2 = medium
3 = heavy
Brochosomes (within Malpigian tubules)
1 = very little; tubule is translucent
2 = medium; tubule is opaque white, not swollen
3 = heavy; tubule is opaque white, swollen

### EXAMPLE 2

### Newly-Eclosed Adult Females

Seven newly eclosed adult female H. coagulata were treated with the compound. The solution was applied with an aerosol device until individuals were noticeable wet. After treatment, female were placed into a wooden 1 m-screened cage that was provisioned with crape myrtle, eastern saltbush, and soybean. Five males of unknown ages were added to the cage. Female were dissected after 36 days. Males were discarded.

As shown in Table 3, no eggs were produced by any treated GWSS females. Dissection of treated females indicated that ovariole (reproductive)-development was inhibited. Under normal green house conditions, female H. coagulata will begin to oviposit 10-12 days after eclosion. A few days prior to oviposition, they have swollen bodies and begin to display brochosomes on the forewings.

TABLE 3
Reproductive status of females 36 days post-treatment

| Female # | Ovarioles | Fat body | Brochosomes | Ova |
|---|---|---|---|---|
| 1 | 2 | 1.5 | 1.5 | 1 |
| 2 | 2 | 2 | 1 | 1 |
| 3 | 2 | 2 | 1 | 1 |
| 4 | 2 | 2 | 1 | 1 |
| 5 | 2 | 2 | 1 | 1 |
| 6 | 2 | 2.5 | 1 | 1 |
| 7 | 2 | 1.5 | 1 | 1 |

### EXAMPLE 3

### Efficacy Studies

The compounds methoprene, kinoprene, and hydroprene will be screened to further characterize their potential efficacy against GWSS and related vectors. A range of rates of the compounds will be evaluated against all GWSS life stages and those of Oncometopia nigricans and Homalodisca insolita to determine LD₅₀s. The tests will require holding the insects for >21 days post treatment on host plants of good quality for observations of feeding, mating, oviposition and other behaviors. Oviposition rates will be quantified and each female dissected to evaluate reproductive status.

The life stages (eggs, 1-2 instars, 4-5 instars, adults) of the three leafhopper species will be systematically evaluated, as well as target the mating and oviposition behavior of diapausing and actively breeding adult males and females. Treatments that assess the residual and potential reversal of activity on female oviposition will be evaluated. The compounds will also be evaluated for their impact on the GWSS egg parasites, G. ashmeadi and G. morrelli by treating GWSS eggs containing the parasite larvae and by treating the adult parasites. The experiments will be conducted in the laboratory and greenhouse using field and greenhouse-raised leafhoppers. For each treatment, 10-20 individuals will be used in each of 3-5 replicates. Treatments will be first applied directly to the insects using an aerosol spray apparatus. Serial dilutions for each compound tested will be evaluated to establish LD₅₀s. Post-treatment the insects will be held on appropriate host plants in the greenhouse and observed for mortality and indirect impacts on their behavior and physiology such as lack of molting, prolonged stadium length, mating and oviposition status. Treatments of adult females will require dissection of the reproductive system and these will be described and quantified as in the preliminary data in Examples 1 and 2. Next, the following activities will be conducted: 1) determine the effects on molting and longevity of each chemical on each life stage of the 3 leafhopper species and the parasites; 2) determine the impact of each chemical on the behavior and reproductive systems of male and female leafhoppers; and 3) establish the dose response relationships of any observed impacts using serial dilutions.

### EXAMPLE 4

### Evaluation of Three Juvenile Hormone (JH) Analogs

The treatment rates for all three: methoprene, kinoprene, and hydroprene are listed below.

| | |
|---|---|
| Control | (Z) |
| 1/100 of recommended dose | (A) |
| 1/10 of recommended dose | (B) |
| recommended dose | (C) |
| 10× recommended dose | (D) |

This example summarizes two ongoing tests involving field-collected gravid females and eggs oviposited less than 24 hours prior to treatment. All of the eggs for all the treatments had red eye spots that were visible through the chorion and the cuticle of the leaf. All appeared to be normal and will most likely eclose within 48 hours. After eclosion the neonates will be held on host plants until death or successful development to the second instar, which ever occurs first.

The mortality of JH analog-treated Homalodisca coagulata females is listed in Table 4. Fifteen females were used for each treatment. Table 4 lists the number of dead female Homalodisca coagulata 10 days post-treatment with three JH analogs. The females will be dissected to determine if there are sub-lethal effects of the JH analogs on the reproductive system.

TABLE 4

| Treatment | methoprene | kinoprene | hydroprene |
|---|---|---|---|
| Z(control) | 0 | 0 | 0 |
| A | 0 | 1 | 3 |
| B | 0 | 1 | 0 |
| C | 0 | 0 | 0 |
| D | 0 | 0 | 14 |

1-21. (canceled)

22. A method for controlling a leafhopper population with an insect growth regulator (IGR), comprising:
contacting said leafhopper population with said IGR; and
affecting the reproductive system of a female leafhopper while in diapause, thereby controlling said leafhopper population.

23. A method for controlling a leafhopper population, wherein said leafhopper population is a glassy-winged sharpshooter (Homolodisca coagulata) population comprising:
contacting said glassy-winged sharpshooter population with an insect growth regulator (IGR); and
affecting the reproductive system of a female leafhopper, wherein said female leafhopper is a female glassy-winged sharpshooter, thereby controlling said glassy-winged sharpshooter population.

24. The method of claim 22, wherein said IGR is a juvenile hormone analog.

25. The method of claim 24, wherein said juvenile hormone analog is selected from the group consisting of epofenonate, fenoxycarb, hydroprene, kinoprene, methoprene, pyriproxyfen, triprene, and a combination of two or more of the foregoing.

26. The method of claim 25, wherein said juvenile hormone analog is selected from the group consisting of methoprene, kinoprene, and hydroprene.

27. The method of claim 26, wherein said juvenile hormone analog is methoprene.

28. The method of claim 23, wherein said female glassy-winged sharpshooter is in diapause.

29. The method of claim 23, wherein said female glassy-winged sharpshooter is a newly enclosed adult glassy-winged female.

30. The method of claim 24, wherein said female leafhopper is reproductively active.

31. The method of claim 24, wherein oviposition of said female leafhopper is suppressed or eliminated.

32. The method of claim 24, wherein said juvenile hormone analog interferes with oviposition of said female leafhopper.

33. The method of claim 22, wherein said female leafhopper is a sharpshooter.

34. The method of claim 33, wherein said female sharpshooter is a glassy-winged sharpshooter (Homolodisca coagulata).

35. The method of claim 22, wherein said IGR is formulated in a formulation selected from the group consisting of a liquid, a spray, a dust, a granule, and an aerosol.

36. The method of claim 22, wherein contacting said leafhopper population is by means selected from the group consisting of spraying, dusting, and sprinkling.

37. The method of claim 24, wherein said juvenile hormone analog is applied to any part of a plant.

38. The method of claim 22, further comprising applying at least one additional pesticidal agent wherein said additional pesticidal agent is not a juvenile hormone analog.

39. A method for controlling a leafhopper population during diapause, comprising contacting said leafhopper population with an insect growth regulator (IGR) during diapause, wherein said IGR affects oviposition of a female leafhopper to thereby control said leafhopper population.

40. The method of claim 39, wherein said IGR is a juvenile hormone analog.

41. The method of claim 39, wherein said juvenile hormone analog is selected from the group consisting of epofenonate, fenoxycarb, hydroprene, kinoprene, methoprene, pyriproxyfen, triprene, and a combination of two or more of the foregoing.

42. The method of claim 39, wherein said female leafhopper is a glassy-winged sharpshooter (Homolodisca coagulata).
